(19) United States
(12) Patent Application Publication
(10) Pub. No.: US 2009/0219654 A1
(43) Pub. Date: Sep. 3, 2009

(54) Two Level Current Limiting Power Supply System

(75) Inventor: John James Fitzpatrick, Indianapolis, IN (US)

Correspondence Address: Thomson Licensing LLC, P.O. Box 5312, Two Independence Way, PRINCETON, NJ, 08543-5312, US

(73) Assignee: MICHAEL A PUGEL, PRINCETON, NJ (US)

(21) Appl. No.: 12/223,437

(22) PCT Filed: Nov. 28, 2006
(86) PCT No.: PCT/US2006/045605

§ 371 Date: Jul. 30, 2008

Related U.S. Application Data
(60) Provisional application No. 60/764,581, filed on Feb. 2, 2006.

(51) Int. Cl. H02H 9/02; G05F 1/573

(52) U.S. Cl. 361/18

(57) ABSTRACT

A two level current limiting power supply system is capable of reducing thermal stress during current overload conditions. According to an exemplary embodiment, the power supply system includes a measurement device for measuring a current supplied to a load, and a processor for disabling the current to the load for a first disable period if the current exceeds a first threshold for a first test period, and for disabling the current to the load for a second disable period if the current exceeds a second threshold for a second test period.

### CROSS REFERENCE TO RELATED APPLICATION

This application claims priority to and all benefits accruing from a provisional application filed in the United States Patent and Trademark Office on Feb. 2, 2006, and there assigned Ser. No. 60/764581.

### BACKGROUND OF THE INVENTION

1. Field of the Invention

The present invention generally relates to power supply systems, and more particularly, to a two level current limiting power supply system capable of reducing thermal stress during overload conditions.

2. Background Information

Single level current limiting power supplies are prone to dissipate excessive power during overload conditions. The concept of power dissipation can be understood from the following example. Assume that a power supply element (e.g., regulator, etc.) typically has a 2 volt drop across it during a normal operating mode. In this example, if the current flowing through the element is 500 milliamps, 1 watt of power (i.e., 2 volts*500 milliamps) must be dissipated by the element. A more serious condition may occur, for example, with a shorted power supply output. In this example, assume that the power supply element (e.g., regulator, etc.) has a 20 volt drop across it when the power supply output is shorted. In this example, if the current flowing through the element is 500 milliamps, 10 watts of power (i.e., 20 volts * 500 milliamps) must be dissipated by element. In the foregoing examples, the risk of thermal stress damage to elements of the power supply may increase as a result of the power dissipation.

One way to address the potential problems associated with excessive power dissipation is to simply build a power supply system with higher current handling capability. However, the problem with increasing the current handling capability of the power supply system is the resulting increase in cost, which may be unacceptable, particularly with cost sensitive applications. Accordingly, it is desirable to create a power supply system that is capable of reducing thermal stress during overload conditions, but that does not add significant cost to the design.

### SUMMARY OF THE INVENTION

In accordance with an aspect of the present invention, an apparatus for protecting a power supply is disclosed. According to an exemplary embodiment, the apparatus comprises first means for measuring a current supplied to a load; and second means for disabling the current to the load for a first disable period if the current exceeds a first threshold for a first test period, and for disabling the current to the load for a second disable period if the current exceeds a second threshold for a second test period.

In accordance with another aspect of the present invention, a method for protecting a power supply is disclosed. According to an exemplary embodiment, the method comprises steps of measuring a current supplied to a load; disabling the current to the load for a first disable period if the current exceeds a first threshold for a first test period; and disabling the current to the load for a second disable period if the current exceeds a second threshold for a second test period.

In accordance with yet another aspect of the present invention, a power supply protection apparatus is disclosed. According to an exemplary embodiment, the power supply protection apparatus comprises a measurement device for measuring a current supplied to a load; and a processor for disabling the current to the load for a first disable period if the current exceeds a first threshold for a first test period, and for disabling the current to the load for a second disable period if the current exceeds a second threshold for a second test period.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram of a power supply system according to an exemplary embodiment of the present invention;

FIG. 2 is a diagram showing further details of the current control circuit of FIG. 1 according to an exemplary embodiment of the present invention;

FIG. 3 is a diagram representing a timing chart according to an exemplary embodiment of the present invention; and

FIG. 4 is a flowchart illustrating steps for protecting a power supply according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

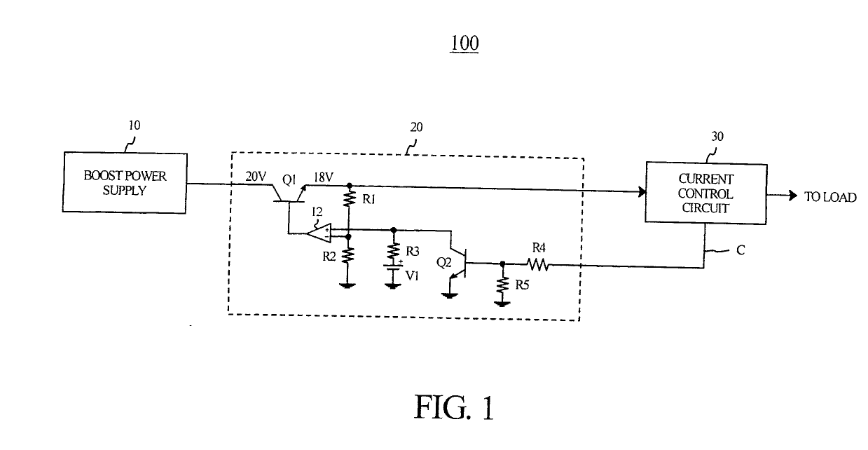

Referring now to the drawings, and more particularly to FIG. 1, a power supply system 100 according to an exemplary embodiment of the present invention is shown. As indicated in FIG. 1, power supply system 100 comprises a boost power supply 10, a regulator 20 and a current control circuit 30. Regulator 20 comprises voltage source V1, resistors R1 to R5, transistors Q1 and Q2, and operational amplifier 12. An exemplary value for voltage source V1 is 5 volts. Exemplary values for resistors R1 to R5 are 10 k ohms, 1 k ohms, 10 k ohms, 10 k ohms and 10 k ohms, respectively. Other values than the foregoing exemplary values could also be used in accordance with design choice.

According to an exemplary embodiment, power supply system 100 is employed in a satellite receiver. According to this exemplary embodiment, power supply system 100 may be embodied within an electronic device such as a set top box, and the load referenced in FIG. 1 may represent a low noise block (LNB) of the satellite receiver. Of course, those skilled in the art will recognize that power supply system 100 may also be employed in other applications.

With power supply system 100 of FIG. 1, there is a risk of thermal stress damage to the elements of regulator 20 due to power dissipation in certain conditions. For example, assume there is typically a 2 volt drop across transistor Q1 of regulator 20 during a normal operating mode, as indicated in FIG. 1. In this scenario, if the current flowing through regulator 20 is 500 milliamps, 1 watt of power (i.e., 2 volts*500 milliamps) must be dissipated by regulator 20. This may be considered a soft fault condition. A more serious, hard fault condition may occur, for example, with a heavier load on regulator 20. For example, assuming there is a 2 volt drop across transistor Q1 of regulator 20 and the current flowing through regulator 20 is 700 milliamps, 1.4 watts of power (i.e., 2 volts*700 milliamps) must be dissipated by regulator 20. As will be described hereinafter, the present invention is capable of handling these types of fault conditions and thereby reducing the risk of thermal stress damage to the elements of regulator 20.

According to principles of the present invention, power supply system 100 uses a two level current limiting technique which reduces thermal stress to regulator 20 during current overload conditions. According to an exemplary embodiment, power supply system 100 employs two current thresholds of 500 and 700 milliamps. If the current flowing through regulator 20 to the load is less than 500 milliamps, power supply system 100 is in a normal operating mode. However, if the current flowing through regulator 20 to the load reaches or exceeds 500 milliamps for a first test period (e.g., 1 second, etc.), current control circuit 30 detects this condition and provides a control signal C to disable (i.e., turn off) regulator 20 for a first disable period (e.g., 1 second, etc.). Moreover, if the current flowing through regulator 20 to the load exceeds 700 milliamps for a second test period (e.g., 35 milliseconds, etc.), current control circuit 30 detects this condition and provides control signal C to disable regulator 20 for a second disable period (e.g., 1.25 seconds, etc.). By disabling regulator 20 in this manner, the present invention advantageously reduces potential thermal stress damage to the elements of regulator 20.

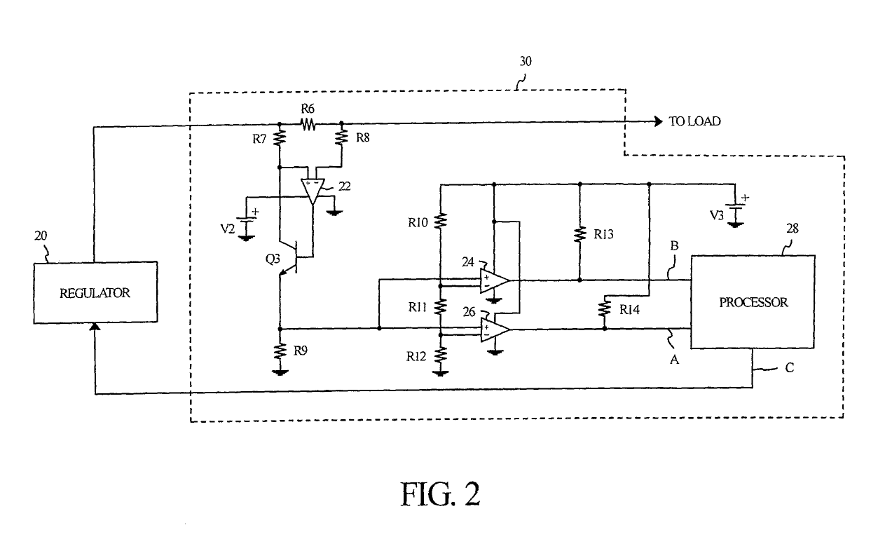

Referring to FIG. 2, a diagram showing further details of current control circuit 30 of FIG. 1 according to an exemplary embodiment of the present invention is shown. As indicated in FIG. 2, current control circuit 30 comprises voltage sources V2 and V3, resistors R6 to R14, transistor Q3, operational amplifier 22, comparators 24 and 26, and processor 28. Exemplary values for voltage sources V2 and V3 are 30 volts and 3.3 volts, respectively. Exemplary values for resistors R6 to R14 are 0.1 ohms, 1 k ohms, 1 k ohms, 33 k ohms, 12 k ohms, 8 k ohms, 20 k ohms, 10 k ohms and 10k ohms, respectively. Other values than the foregoing exemplary values could also be used in accordance with design choice.

In FIG. 2, operational amplifier 22 and its associated circuitry operate as a measurement device for measuring the magnitude of the current provided to the load (e.g., LNB). According to an exemplary embodiment, voltage source V2, resistors R6 to R9, transistor Q3 and operational amplifier 22 operate as a current-to-voltage transducer which produces a voltage having a magnitude that corresponds to the magnitude of the current provided to the load. Comparators 24 and 26 receive the output voltage produced from this current-to-voltage transducer and operate as threshold detectors to thereby detect if the current provided to the load (which corresponds to the output voltage of the current-to-voltage transducer) reaches certain predetermined thresholds.

According to an exemplary embodiment, comparator 26 provides a first detection signal A in a logic high state to processor 28 if the current provided to the load equals or exceeds a first threshold of 500 milliamps. First detection signal A is in a logic low state if the current provided to the load is less than the first threshold of 500 milliamps. Also according to this exemplary embodiment, comparator 24 provides a second detection signal B in a logic high state to processor 28 if the current provided to the load exceeds a second threshold of 700 milliamps. Second detection signal B is in a logic low state if the current provided to the load is less than or equal to the second threshold of 700 milliamps.

Processor 28 is operative to control the current provided to the load in response to the first and second detection signals A and B provided from comparators 26 and 24, respectively. According to the exemplary embodiment described herein, if the current flowing through regulator 20 to the load is less than 500 milliamps, power supply system 100 is in a normal operating mode. However, if the current flowing through regulator 20 to the load reaches or exceeds 500 milliamps for a first test period (e.g., 1 second, etc.), processor 28 detects this condition in response to the first detection signal A from comparator 26 being in a logic high state, and provides control signal C to disable (i.e., turn off) regulator 20 for a first disable period (e.g., 1 second, etc.). Moreover, if the current flowing through regulator 20 to the load exceeds 700 milliamps for a second test period (e.g., 35 milliseconds, etc.), processor 28 detects this condition in response to the second detection signal B from comparator 24 being in a logic high state, and provides control signal C to disable regulator 20 for a second disable period (e.g., 1.25 seconds, etc.). By disabling regulator 20 in this manner, the present invention advantageously reduces potential thermal stress damage to the elements of regulator 20. It is noted that the specific current thresholds, test periods and disable periods referred to herein are exemplary only, and that other current thresholds, test periods and disable periods may also be employed as a matter of design choice in accordance with principles of the present invention.

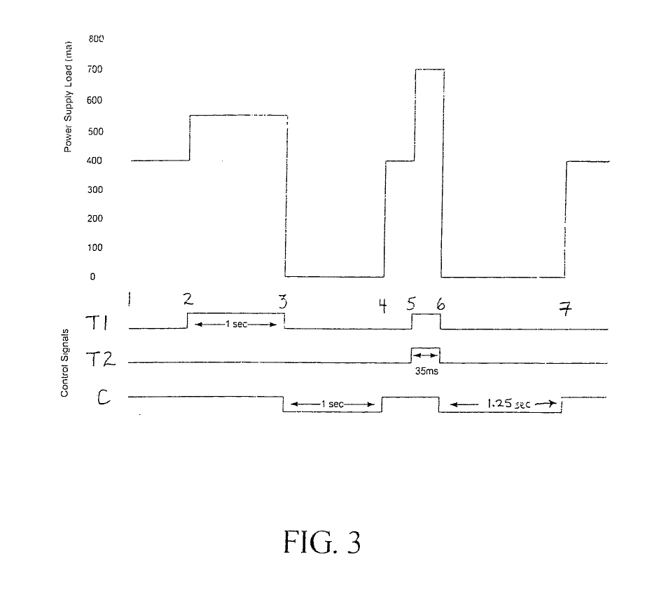

Referring to FIG. 3, a diagram representing a timing chart according to an exemplary embodiment of the present invention is shown. In particular, the timing chart of FIG. 3 illustrates the above-described operation of processor 28. At time 1, the current to the load is less than 500 milliamps and power supply system 100 is in the normal operating mode. At time 2, the current to the load exceeds 500 milliamps causing comparator 26 to output the first detection signal A in a logic high state. Processor 28 responds to the first detection signal A in a logic high state by starting a first internal timer T1 which is used to measure the first test period (e.g., 1 second, etc.). When the first internal timer T1 elapses at time 3, processor 28 outputs control signal C to disable (i.e., turn off) regulator 20 for a first disable period (e.g., 1 second, etc.), which ends at time 4 where the current to the load is re-enabled. Next, at time 5, the current to the load exceeds 700 milliamps causing comparator 24 to output the second detection signal B in a logic high state. Processor 28 responds to the second detection signal B in a logic high state by starting a second internal timer T2 which is used to measure the second test period (e.g., 35 milliseconds, etc.). When the second internal timer T2 elapses at time 6, processor 28 outputs control signal C to disable regulator 20 for a second disable period (e.g., 1.25 seconds, etc.), which ends at time 7 where the current to the load is re-enabled.

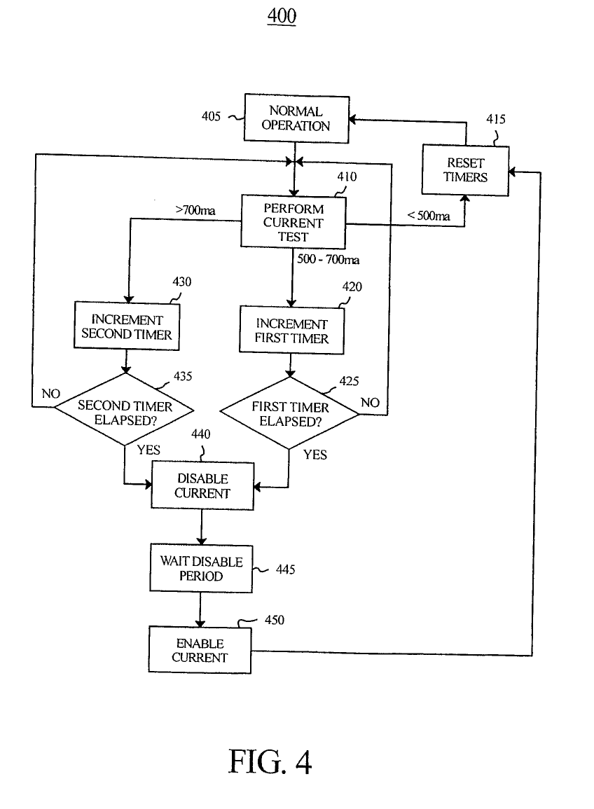

Referring to FIG. 4, a flowchart 400 illustrating steps for protecting a power supply according to an exemplary embodiment of the present invention is shown. For purposes of example and explanation, the steps of FIG. 4 will be described with reference to power supply system 100 of FIG. 1 and current control circuit 30 shown in FIG. 2. The steps of FIG. 4 are exemplary only, and are not intended to limit the present invention in any manner.

At step 405, power supply system 100 is in a normal operating mode. At step 410, a current test is performed to measure the magnitude of the current being provided to the load (e.g., LNB). According to an exemplary embodiment, current control circuit 30 generates a voltage having a magnitude that corresponds to the magnitude of the current provided to the load (e.g., LNB). According to this exemplary embodiment, voltage source V2, resistors R6 to R9, transistor Q3 and operational amplifier 22 of current 30 control circuit 30 operate as a current-to-voltage transducer which produces a voltage having a magnitude that corresponds to the magnitude of the current provided to the load. Comparators 24 and 26 receive the output voltage provided from this current-to-voltage transducer and detect if the current provided to the load (which corresponds to the output voltage of the current-to-voltage transducer) reaches certain predetermined thresholds. According to an exemplary embodiment, comparator 26 provides first detection signal A in a logic high state to processor 28 if the current provided to the load equals or exceeds a first threshold of 500 milliamps, and comparator 24 provides second detection signal B in a logic high state to processor 28 if the current provided to the load exceeds a second threshold of 700 milliamps. Accordingly, processor 28 determines the magnitude of the current provided to the load based on the logic states of the first and second detection signals A and B.

If the current test of step 410 indicates that the current is less than 500 milliamps, process flow advances to step 415 where processor 28 resets first and second internal timers T1 and T2 to predetermined initial values (e.g., zero). As previously indicated above, these first and second timers T1 and T2 measure first and second test periods, respectively. From step 415, process flow loops back to step 405 where the normal operating mode occurs.

If the current test of step 410 indicates that the current is greater than or equal to 500 milliamps but less than or equal to 700 milliamps, process flow advances to step 420 where processor 28 increments its first timer T1. From step 420, process flow advances to step 425 where processor 28 determines whether first timer T1 has elapsed. According to an exemplary embodiment, first timer T1 elapses when it reaches 1 second, which corresponds to the exemplary first test period. If first timer T1 has not elapsed at step 425, process flow loops back to step 410 where the current test is performed again.

If the current test of step 410 indicates that the current is greater than 700 milliamps, process flow advances to step 430 where processor 28 increments its second timer T2. From step 430, process flow advances to step 435 where processor 28 determines whether second timer T2 has elapsed. According to an exemplary embodiment, second timer T2 elapses when it reaches 35 milliseconds, which corresponds to the exemplary second test period. If second timer T2 has not elapsed at step 435, process flow loops back to step 410 where the current test is performed again.

If processor 28 determines that first timer T1 has elapsed at step 425 or that second timer T2 has elapsed at step 435, process flow advances to step 440 where processor 28 disables the current to the load. According to an exemplary embodiment, processor 28 disables the current to the load by outputting control signal C (see FIGS. 2 and 3). From step 440, process flow advances to step 445 where processor 28 waits for the applicable disable period. According to an exemplary embodiment, processor 28 waits for a first disable period (e.g., 1 second, etc.) at step 445 if first timer T1 has elapsed at step 425, and waits for a second disable period (e.g., 1.25 seconds, etc.) at step 445 if second timer T2 has elapsed at step 435. After processor 28 watts for the applicable disable period at step 445, process flow advances to step 450 where processor 28 re-enables the current to the load by shifting the logic state of control signal C (see FIG. 3). From step 450, process flow loops back to step 415 where processor 28 resets the first and second timers T1 and T2 back to predetermined initial values (e.g., zero).

As described herein, the present invention provides a two level current limiting power supply system capable of reducing thermal stress during current overload conditions. It is again noted that a preferred embodiment of the present invention has been described herein with reference to specific current thresholds, test periods and disable periods which are exemplary only, and are not intended to limit the present invention in any manner. Those skilled in the art will recognize that other current thresholds, test periods and disable periods may also be employed as a matter of design choice. The present invention may be applicable to various types of applications that employ a power supply system. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus for protecting a power supply, said apparatus comprising:
first means for measuring a current supplied to a load; and
second means for disabling said current to said load for a first disable period if said current exceeds a first threshold for a first test period, and for disabling said current to said load for a second disable period if said current exceeds a second threshold for a second test period.

2. The apparatus of claim 1, wherein:
said first threshold is less than said second threshold;
said first disable period is shorter than said second disable period; and
said first test period is longer than said second test period.

3. The apparatus of claim 1, wherein said load comprises a low noise block of a satellite receiver.

4. The apparatus of claim 1, further comprising:
third means for providing a first detection signal to said second means if said current exceeds said first threshold; and
fourth means for providing a second detection signal to said second means (28) if said current exceeds said second threshold.

5. The apparatus of claim 1, wherein said first means generates a voltage corresponding to said current.

6. The apparatus of claim 1, wherein said second means enables said current to said load after said current is disabled for one of said first and second disable periods.

7. A method for protecting a power supply, comprising steps of:
measuring a current supplied to a load;
disabling said current to said load for a first disable period if said current exceeds a first threshold for a first test period; and
disabling said current to said load for a second disable period if said current exceeds a second threshold for a second test period.

8. The method of claim 7, wherein:
said first threshold is less than said second threshold;
said first disable period is shorter than said second disable period; and
said first test period is longer than said second test period.

9. The method of claim 7, wherein said load comprises a low noise block of a satellite receiver.

10. The method of claim 7, further comprising steps of:
generating a first detection signal if said current exceeds said first threshold; and
generating a second detection signal if said current exceeds said second threshold.

11. The method of claim 7, wherein said measuring step (410) includes generating a voltage corresponding to said current.

12. The method of claim 7, further comprising a step of enabling said current to said load after said current is disabled for one of said first and second disable periods.

13. A power supply protection apparatus comprising:
a measurement device for measuring a current supplied to a load; and
a processor for disabling said current to said load for a first disable period if said current exceeds a first threshold for a first test period, and for disabling said current to said load for a second disable period if said current exceeds a second threshold for a second test period.

14. The power supply protection apparatus of claim 13, wherein:
said first threshold is less than said second threshold;
said first disable period is shorter than said second disable period; and
said first test period is longer than said second test period.

15. The power supply protection apparatus of claim 13, wherein said load comprises a low noise block of a satellite receiver.

16. The power supply protection apparatus of claim 13, further comprising:
a first comparator coupled to said measurement device for providing a first detection signal to said processor if said current exceeds said first threshold; and
a second comparator coupled to said measurement device for providing a second detection signal to said processor if said current exceeds said second threshold.

17. The power supply protection apparatus of claim 13, wherein said measurement device generates a voltage corresponding to said current.

18. The power supply protection apparatus of claim 13, wherein said processor enables said current to said load after said current is disabled for one of said first and second disable periods.
